(19) United States
(12) Patent Application Publication
(10) Pub. No.: US 2004/0089648 A1
(43) Pub. Date: May 13, 2004

(54) Open coil heater element convection system for convection ovens and the like

(76) Inventors: Dean J. Griffey, Cleveland, TN (US); Michael A. McKinney, Verona, WI (US); Mark Straub, Janesville, WI (US)

Correspondence Address: FOLEY & LARDNER, 150 EAST GILMAN STREET, P.O. BOX 1497, MADISON, WI, 53701-1497, US

(21) Appl. No.: 10/629,353

(22) Filed: Jul. 28, 2003

Related U.S. Application Data
(60) Provisional application No. 60/399,210, filed on Jul. 29, 2002.

(51) Int. Cl. A21B 1/26; A21B 1/00

(52) U.S. Cl. 219/400; 219/391; 219/413

(57) ABSTRACT

A convection oven includes an open coil heater element around a radial fan which expels air radially outward and through the coils of the heating element. A controller permits air temperature regulation and self-protection of the coil against over-temperature conditions, for example as a result of failure of the coil or failure of the motor that drives the fan.

### CROSS REFERENCE TO RELATED APPLICATION

This application claims the benefit of provisional patent application No. 60/399,210, filed Jul. 29, 2002, the disclosure of which is incorporated by reference.

### FIELD OF THE INVENTION

This invention pertains generally to the field of cooking appliances such as convection ovens and particularly to electric heating element systems used in such appliances.

### BACKGROUND OF THE INVENTION

Conventionally, ovens cook food by transferring heat energy from a controlled heating element to air that circulates in a cooking chamber in which food to be cooked is placed. The heat transfer rate from the heating element to the circulating air depends largely on heating element design and air flow. In a conventional oven, heated air circulates naturally due to rising convection currents, but in a forced air convection oven, such passive airflow is augmented by an active fan or blower. A control system that regulates operation of the heating element and a fan are necessary to achieve a desired air temperature for cooking. Convection cooking is accomplished as the air that is heated to a regulated temperature circulates around the food to be cooked.

Many commercially available convection ovens use electric resistance type heating elements. A typical electric resistance heating element, commonly referred to as a Calrod unit, employs a heating element coil insulated by a form of crystalline magnesium oxide (MgO) and an outer metallic sheath. For an exemplary forced air convection oven that uses a Calrod unit, see U.S. Pat. No. 5,107,097. A second type of electric resistance heating element, commonly referred to as open coil, consists generally of a helically wound resistance wire. For an exemplary convection oven that uses an open coil element, see U.S. Pat. No. 5,466,912. In contrast to the Calrod unit, in which the resistance wire is sheathed in an MgO insulator, the open coil resistance wire is exposed. As a result, heat transfer occurs from the surface of the resistance wire directly to the air. Although either type of element can be formed into a variety of shapes, a Calrod unit is rigid while the open coil element is flexible. Because it is flexible, the open coil element requires spaced insulating supports to provide shape to the element and to prevent electrical shorting to the metallic cooking chamber surface to which the element is mounted. For an illustration of insulating spacers for use with an open coil heating element, see U.S. Pat. No. 6,020,577.

Effective control of the convection oven heating element is critical to producing reliable cooking quality. Because the air temperature profile over time determines the degree to which the food is cooked, reliable cooking quality depends on the accurate control of air temperature. Temperature control accuracy is limited by both the delay in warm-up time after energizing the heating element and the delay in cool-down time after de-energizing the heating element. In Calrod units, significant thermal delays can result due to their relatively large thermal mass and their relatively limited heat transfer rate. By comparison, open coil elements can transition to a desired temperature much faster as a consequence of their inherently smaller thermal mass and their higher heat transfer rate in the presence of an airflow. Therefore, for a given power rating, open coil elements generally respond to control commands much faster than Calrod units.

The controller in an open coil heater element convection system impacts the continuous and reliable operation of the convection oven. Open coil elements have a recognized sensitivity to excessive temperatures which can lead to localized melting and consequential opening of the open coil resistance wire. The occurrence of such a failure interrupts current in the open coil element resistance wire. To maximize the mean time between failures due to such over-temperature conditions, a controller in the open coil element convection system must minimize the occurrence of over-temperature conditions through monitoring and self-protection.

Circulation of air in convection ovens is known to improve conventional oven cooking quality. A moderate amount of air circulation results in more even air temperature distribution around the food in the oven, which leads to reduced cooking times and improved cooking quality, although an excessive amount of air circulation can damage some foods such as delicate pastries. A forced air convection oven typically incorporates a baffle, comprised of a formed sheet metal wall, to divide the oven cavity into a cooking chamber, into which food is placed, and a fan chamber. Although a baffle can function as a protective cover over the rotating fan blades, it also can serve to direct fan exhaust into the cooking chamber to produce an air flow pattern that will evenly distribute air temperature in the cooking chamber.

### SUMMARY OF THE INVENTION

In accordance with the present invention, an open coil heater element convection cooking system including a fan has a simple structure that is well suited for use in high performance, forced air convection ovens. The heating system of the present invention is capable of very fast warm-up and cool-down times, and is capable of regulating oven air temperature with high precision to reach and maintain a temperature selected by the user. The heating system of the invention provides higher precision and faster responding temperature control than can be obtained with either Calrod units or conventional open coil arrangements. The heating system of the invention further preferably includes a controller capable of operating in a self-protecting fashion that extends the operational life of the open coil element. The heating system of the invention may be operated with a variety of self-protecting modes if desired.

The present invention includes an open coil heating element formed around a radial fan. The fan forces air radially outward in the plane of fan blade rotation, and the resulting airflow passes through an open coil heating element, that can include, for example, a helically wound or ribbon, crimped or non-crimped, resistance wire. When electrically energized, the open coil heating element heats up and transfers heat energy to the fan exhaust air as it passes through the open coil heating element. The resulting heated air flows from the heating element and fan, typically through a baffle system, to cook the food in the cooking chamber. The heating system of the present invention may further include a controller that monitors and regulates the operation of the fan and the open coil heating element in response to user input commands and any fault conditions, such as fan or coil failure, that may be detected.

The controller for the heating system preferably permits a user to select a desired oven air temperature by setting a temperature selection input device such as, for example, a control dial. Precise air temperature regulation requires the controller to energize the open coil heating element in such a manner that the oven air temperature closely tracks the temperature selected by the user. Precise tracking implies fast dynamic response, which requires minimum thermal mass and maximum heat transfer both during temperature transitions and during steady-state cooking operation. In convection cooking, transitions generally involve step changes, such as turning a heating element on or off. An open coil heating element as employed in the present invention can respond to such step changes with minimal thermal delay, due to both the relatively low inherent thermal mass and the lack of electrical insulation that would increase thermal mass. In addition to low thermal mass, an open coil heating element in accord with the present invention has excellent surface watt density compared to alternative convection oven heating elements; consequently, open coil heating elements exhibit superior heat transfer in an airflow stream. This excellent heat transfer allows oven air temperature to relatively closely track the open coil temperature. Therefore, the open coil heating element of the present invention can be operated with a relatively low peak temperature in a typical bang-bang regulation scheme. Lowering the peak temperature of the open coil heating element provides several advantages, including: reduced localized heating that can overcook food; reduced peak thermal stress on oven components, leading to lower system cost and longer mean time between failures; and shortened temperature transition times as a consequence of reduced peak-to-peak temperature variations. Peak-to-peak temperature variations contemplate, for example, a bang-bang type of control; however, any suitable technique known to those skilled in the art would obtain these advantages.

The open coil heating element and radial fan arrangement of the present invention provides very fast dynamic response relative to typical Calrod heating elements because Calrod units typically include the thermal mass of an insulation, such as MgO, that increases thermal lag time, and because Calrod units have poorer heat transfer rates due to their higher surface watt density. The arrangement of the present invention also has superior dynamic response relative to prior art structures that include an open coil element and a fan. In the present invention, the airflow across the open coil heating element is maximized because it includes the full primary fan exhaust which maximizes the heat transfer rate.

Although the open-coil convection system provides clear controllability advantages, open coils typically require self-protection to prevent premature heating element failure. Self-protection of the heating system requires the controller to respond to certain conditions that indicate failure modes. A dominant failure mode is an over-temperature condition that can lead to the heating element fusing open. One foreseeable cause of such a condition is the reduction of heat transfer resulting from an unexpected loss of fan airflow output. The present invention provides for self-protection against conditions such as loss of fan airflow, and this result can be achieved in many ways. In a first exemplary embodiment, the controller detects a heating element over-temperature condition by comparing a temperature sensor feedback signal to a threshold. If the threshold is exceeded, the controller de-energizes the heating element. In a second exemplary embodiment, the controller monitors motor current to verify that motor current remains within expected levels. If the motor current goes outside the range of the expected levels, this is interpreted as a motor operational problem, such as a stalled shaft, and the controller de-energizes the open coil heating element and the fan to prevent over-temperature failure. These examples are merely illustrative, and this result may be accomplished in a variety of ways.

A convection system in accordance with the present invention may utilize multiple temperature sensors, each optimized to carry out a particular function. One or more cooking chamber temperature sensors may be provided to provide feedback to the controller to enable precision air temperature regulation in accordance with the present invention. One or more heating element temperature sensors may also be provided, so the controller can detect and respond to over-temperature conditions in the heating element that can lead to the heating element fusing open, to enable self protection of the open coil heating element in accordance with the present invention as discussed above. In a preferred embodiment, multiple temperature sensors are used because the optimal location and characteristics of a cooking chamber temperature sensor used for air temperature regulation may not be the same as the optimal location and characteristics of a coil temperature sensor used for detection of over-temperature conditions in the open coil. Additional temperature sensors may also be provided, such as a heat-resistant probe temperature sensor used to monitor the internal temperature of foods such as meats during cooking.

In a preferred embodiment, a cooking chamber temperature sensor is preferably located in the cooking chamber at a location chosen to optimize measurement of air temperature within the cooking chamber. Although the primary purpose of this temperature sensor is to monitor the air temperature in the cooking chamber, it may also allow detection of over-temperature conditions in the heating element, instead of, in addition to, or in combination with a special coil temperature sensor.

In a preferred embodiment, an open coil heating element temperature sensor is also provided, which is preferably mounted approximately directly above the heating element and in the fan exhaust air flow, e.g., between about 0.5 cm and 5 cm above the heating element. This location is optimal for detecting over-temperature conditions in the heating element because of its proximity to naturally rising convection currents from the heating element, especially if the fan is not operating. Although the primary purpose of this temperature sensor is to monitor the heating element temperature, it may also allow detection of air temperature in the cooking chamber, instead of, in addition to, or in combination with the cooking chamber temperature sensor.

Further objects, features and advantages of the invention will be apparent from the following detailed description when taken in conjunction with the accompanying drawings.

### BRIEF DESCRIPTION OF THE DRAWINGS

In the drawings:

FIG. 1 is a front view of a convection oven (with the fan baffle removed) including an exemplary open coil heating element convection system in accordance with the invention.

FIG. 2 is a schematic side view block diagram of an embodiment of an open coil heating element convection system including a controller in accordance with the invention.

FIG. 3 is a fragmentary perspective view of an exemplary open coil heating element and fan in accordance with the invention.

FIG. 4 is a fragmentary perspective view of an embodiment of an oven temperature sensor in accordance with the invention.

### DETAILED DESCRIPTION OF THE INVENTION

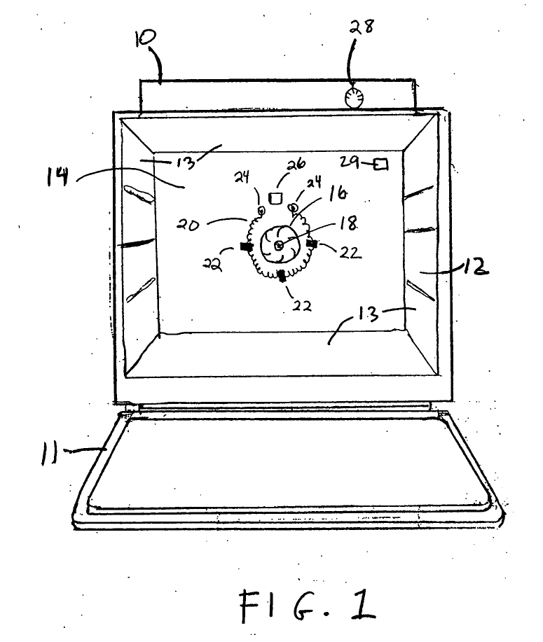

With reference to the drawings, FIG. 1. illustrates a typical convection oven 10 having an oven door 11. For the purpose of illustrating the invention, a baffle is not shown in FIG. 1, although it is understood that a baffle generally will be mounted to shield the fan from objects in the interior of the oven. The open coil element convection system of the invention is preferably located inside an oven cavity 12 defined by the door 11 and oven walls, including side walls 13 and a back wall 14.

As shown in FIG. 1, the invention includes a fan 16 for forcing air radially outward from its axis of rotation. The fan 16 is preferably a radial-type fan, but can be any fan arrangement capable of creating multi-directional radial airflow. Rotation of the fan 16 around an axis is accomplished by connection to a drive shaft 18 that delivers torque. Preferably, the drive shaft 18 passes through the oven cavity rear wall 14 so that it can be driven by a motor, such as an electric motor, located outside of oven cavity 12.

As shown in FIG. 1, an exemplary open coil heating element 20 is located around the fan 16 and inside the oven cavity 12. The open coil heating element 20 preferably comprises a helically wound resistance wire that is attached to the rear wall 14 at several locations by insulating spacers 22, although that particular construction is not required, and the open coil heating element could include, for example, a helically wound or ribbon, crimped or non-crimped, resistance wire or similar heating element. The spacers 22 provide support to open coil element 20 and maintain its physical and electrical separation from the rear wall 14. The number and locations of the spacers 22 determine the shape of the open coil element 20. As shown in the exemplary embodiment of FIG. 1, preferably three of the spacers 22 are located to form the heating coil 20 into a generally circular shape around the perimeter of the fan 16. In the exemplary embodiment of the invention shown in FIG. 1, the circular shape includes a gap to provide for electrical connections to the open coil heating element 20. The open coil element 20 can be electrically connected, for example, to two terminal posts 24 that feed through the rear wall 14. The terminal posts 24, which preferably have ceramic insulator bushings and steel conductors, electrically insulate the open coil heating element 20 from the metallic surface of the rear wall 14.

As shown in the exemplary embodiment shown in FIG. 1, a coil temperature sensor 26 is mounted to the rear wall 14, located preferably centered and above the open coil element 20, and a separate cooking chamber temperature sensor 29 is also provided, located in the cooking chamber itself. The coil temperature sensor 26 and the cooking chamber temperature sensor 29 are preferably the resistance-temperature detector (“RTD”) type, but they could be any other type of sensor with suitable accuracy and reliability over the expected range of temperatures, or they could include a thermal fuse or similar device. The coil temperature sensor 26 or the cooking chamber temperature sensor 29 or both can thus be used to detect or respond to a coil over-temperature condition or to measure an actual oven air temperature for use by a system controller 30.

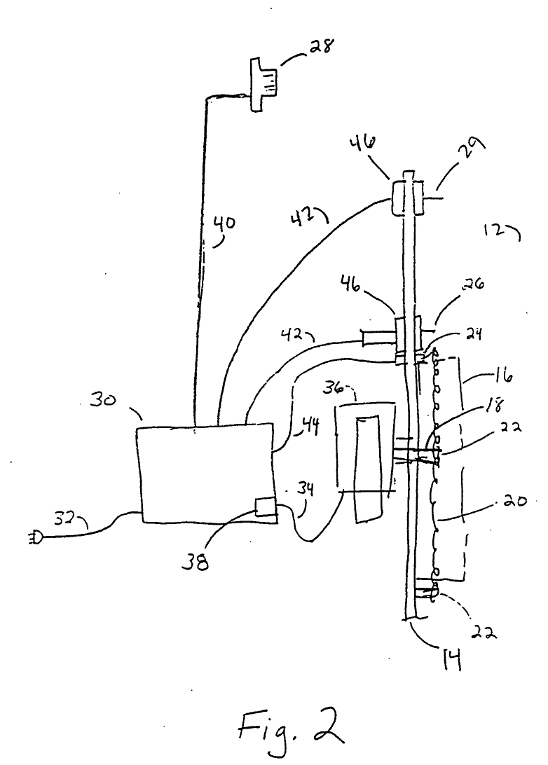

As shown in FIG. 2, the invention can be implemented with a system controller 30, preferably located outside of the oven cavity 12, to provide monitoring and control functions. The system controller 30 may be implemented in various ways by those skilled in the art to perform the functions described below, using conventional digital and/or analog circuitry including integrated circuits and/or discrete devices. In the exemplary embodiment of the invention, a temperature selector input 28 is mounted on an external surface of the convection oven 10 that is accessible to a user. The temperature selector input 28 is conventionally a rotary dial connected to a potentiometer, but may be any suitable interface such as, for example, a key-press input interface with a digital display. The system controller 30 monitors temperature selector input 28 and responds to user input changes by appropriately applying power to the fan 16 and to the open coil heating element 20. The system controller 30 energizes the fan 16 by applying electrical power from an AC power line input 32 to motor control leads 34. The motor control leads 34 deliver electrical power from the system controller 30 to the motor 36, which preferably is an induction motor but could be any electric motor suitable for driving the fan drive shaft 18. The motor 36 is attached to the drive shaft 18 such that it communicates motor torque to the fan 16.

In a preferred embodiment, the system controller 30 also provides self-protection of the open coil by monitoring the coil temperature and/or detecting coil over-temperature conditions using the coil temperature sensor 26. The system controller 30 may also monitor the current in the motor control leads 34 using a motor current sensor 38 to determine whether motor current falls outside expected operating ranges. Preferably, the motor current sensor 38 is a series resistive current sensor monitored by a threshold comparator, wherein the resistor, comparator, and associated circuitry are integrated internally into the system controller 30. The motor current sensor 38 could comprise other current sensors well known in the industry, such as, for example, Hall effect current sensors or current transformers. If either the coil temperature or the motor current falls out of the expected range, power to the open coil is turned off.

Accurately regulating oven air temperature to the temperature desired by the user requires both that the temperature selector input 28 communicates the desired temperature to the system controller 30, through temperature selector leads 40 and that the cooking chamber temperature sensor 29 communicates the actual oven air temperature to the system controller 30, through temperature sensor leads 42. In response to differences between desired and actual temperature, the system controller 30 appropriately applies or removes power to the open coil heating element 20 through heating element control leads 44. The system controller 30 also applies power to the motor 36, preferably whenever power is applied to the open coil heating element 20 so that the radial airflow provides adequate heat transfer to prevent over-temperature conditions in the open coil element. If desired, the system controller 30 may operate the motor 36 when no power is applied to the open coil heating element 20 to provide, for example, airflow to cool the open coil heating element 20, or simply to provide forced air circulation in the oven 10.

Preferably, the temperature sensor leads 42 connect the system controller 30 to the coil temperature sensor 26 through a feed-through connector 46 protruding through the oven cavity rear wall 14, wherein the feed-through connector 46 not only locates and supports the sensor in the oven cavity 12, but it also isolates the connection between the leads 42 and the sensor 26 from the rear wall 14. The cooking chamber temperature sensor 29 may be connected to the system controller 30 in a similar fashion. The cooking chamber temperature sensor 29 may be located on the oven cavity rear wall 14, as shown in the exemplary embodiment shown in FIG. 1, or it may be located elsewhere such as on an oven cavity side wall 13. Preferably, the heating element control leads 44 connect the system controller 30 to the open coil heating element 20 through the terminal posts 24 that protrude through the oven cavity rear wall 14.

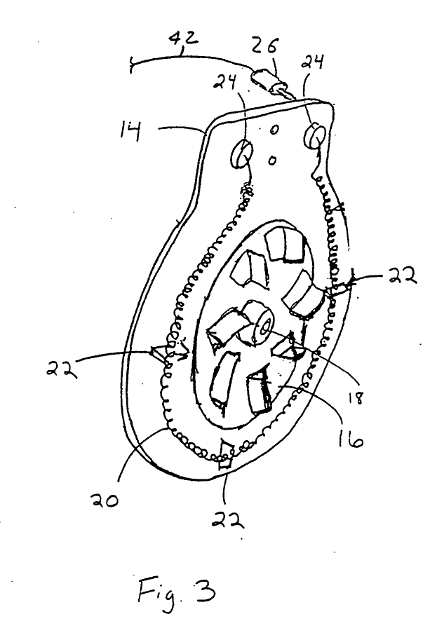

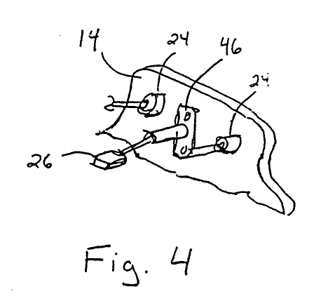

FIGS. 3 and 4 show in more detail the configuration of elements located inside the oven cavity 12 in the vicinity of the open coil in an exemplary embodiment of the invention. As best shown in FIG. 4, the coil temperature sensor 26 extends from the feed-through connector 46 so as to be fully exposed to the airflow from the fan 16. The feed-through connector 46 may be located generally centered between the terminal posts 24 and generally directly above the axis of rotation of the fan 16 and the shaft 18. In an exemplary embodiment of the invention, the coil temperature sensor 26 is an RTD that is mounted approximately directly above and in the exhaust air flow of the fan 16 (e.g., between about 0.5 cm and about 5 cm therefrom). This location is optimal for detecting over-temperature conditions based on the proximity to naturally rising convection currents, especially if the fan is not operating; however, alternatively, the coil temperature sensor 26 may be located at another position around the perimeter of the fan 16. Although the radial path from the fan 16 to the coil temperature sensor 26 does not pass through the open coil heating element 20 in the exemplary embodiment shown in FIGS. 2 and 3, the invention may be implemented such that the radial path from the fan 16 to the coil temperature sensor 26 passes through the heating element 20.

The open coil heating element 20 preferably surrounds the perimeter of the fan 16 such that almost all the radial airflow from the fan 16 passes through the coils of the open coil heating element 20. When electrically energized, the open coil heating element 20 thereby efficiently transfers heat to this radial airflow.

In a preferred embodiment of the invention, the system controller 30 monitors at least two inputs to prevent premature failure of the open coil heating element 20. First, the system controller 30 monitors the coil temperature sensor 26 for temperatures that exceed rated coil operational specifications. This temperature rating is preferably based on MTBF, but could be based on any other desired reliability metric. Second, the system controller 30 monitors the current in the motor control leads 34 using a motor current sensor 38. In the event that the fan 16 is prevented from rotating freely, motor current will increase due to a reduction of back-e.m.f. (electro-motive force) voltage that naturally develops during free rotation. If the fan 16 is prevented from rotating freely, then the airflow across the open coil heating element 20 will decrease, resulting in reduced heat transfer from the coils, which can lead to the coils overheating. To avoid this result, the system controller 30 preferably detects when the motor current falls outside a normal range and responds by de-energizing both the motor 36 and the open coil heating element 20. Although in the preferred embodiment system controller 30 measures both temperature and motor current, the system controller 30 may measure and respond to only one of these conditions.

To avoid unnecessary exposure to oven temperature air, any elements of the invention that need not be located in the oven cavity 12 are preferably located outside of the walls defining the oven cavity 12. Preferably, the motor 36 is located on the opposite side of the oven cavity rear wall 14 from the fan 16, and operates by coupling directly to the drive shaft 18.

In energizing either the motor 36 or the open coil heating element 20, the system controller 30 may provide appropriate power conditioning such as rectification, phase-control modulation, ac-dc conversion, dc-ac inversion, amplitude regulation, magnetic coupling, or any other known technique to effect operation of these two elements. However, in a simple preferred embodiment, the system controller 30 provides power through a relay and either directly to the AC power line input 32 or through a transformer that may provide isolation or modify the applied voltage.

In the preferred mode of operation of the invention, the fan 16 operates whenever the open coil heating element 20 is energized. However, the invention encompasses modes in which the system controller 30 can operate these elements independently.

It is understood that the invention is not confined to the particular embodiments set forth herein as illustrative, but embraces all such forms thereof as come within the scope of the following claims.

What is claimed is:

1. An open coil convection system for convection ovens comprising:
(a) a motor for rotating a shaft;
(b) a fan coupled to the shaft and configured to produce a radial airflow directed outward from the fan; and
(c) an open coil heating element positioned around the fan such that the radial airflow passes through the open coil heating element thereby transferring heat from the open coil heating element to the radial airflow.

2. The open coil convection system of claim 1 wherein the open coil heating element comprises a helically wound resistance wire having a plurality of supporting insulators along its length.

3. The open coil convection system of claim 1 further comprising:
(a) a temperature sensor for measuring an actual oven air temperature;
(b) a temperature selector permitting a user to input a desired oven air temperature; and
(c) a controller operatively coupled to receive the actual oven air temperature from the temperature sensor and operatively coupled to receive the desired oven air temperature from the temperature selector, wherein the controller is adapted to supply power to the open coil heating element when the difference between the actual oven air temperature and the desired oven air temperature exceeds a specified threshold.

4. The open coil convection system of claim 3 wherein the controller is further adapted to supply power to the fan, and wherein power is supplied to the fan at least when power is supplied to the open coil heating element.

5. The open coil convection system of claim 3 wherein the temperature sensor is located above the open coil heating element whereby the temperature sensor is adapted to detect an over-temperature condition in the open coil heating element.

6. The open coil convection system of claim 5 wherein power is not supplied to the open coil heating element when the temperature sensor indicates an over-temperature condition in the open coil heating element.

7. The open coil convection system of claim 1 further comprising:
(a) a current sensor for measuring a current through the motor; and
(b) a controller operatively coupled to the current sensor and adapted to supply power to the open coil heating element, wherein the controller removes power to the open coil heating element when the current sensor indicates the current through the motor exceeds a selected maximum threshold.

8. The open coil convection system of claim 7 further comprising a temperature sensor located above the open coil heating element, wherein the controller is operatively coupled to the temperature sensor, and wherein the controller does not supply power to the open coil heating element when the temperature sensor indicates an over-temperature condition in the open coil heating element.

9. The open coil convection system of claim 1 further comprising:
(a) a current sensor for measuring a current through the motor; and
(b) a controller operatively coupled to the current sensor and adapted to supply power to the open coil heating element, wherein the controller removes power to the open coil heating element when the current sensor indicates the current through the motor is below a selected minimum threshold.

10. The open coil convection system of claim 9 further comprising a temperature sensor located above the open coil heating element, wherein the controller is operatively coupled to the temperature sensor, and wherein the controller does not supply power to the open coil heating element when the temperature sensor indicates an over-temperature condition in the open coil heating element.

11. A method of operating an open coil element convection system in a convection oven comprising:
(a) applying power to a motor, wherein the motor rotates a shaft that is coupled to a fan, and wherein the fan is configured for producing a radial airflow directed outward; and
(b) simultaneously applying electric power to an open coil heating element formed around the fan wherein the open coil heating element converts at least a portion of the applied electric power to heat and wherein at least half of the radial airflow passes through the open coil heating element, thereby transferring heat from the open coil heating element to at least a portion of the radial airflow.

12. The method of claim 11, further comprising:
(a) measuring an actual air temperature of air within a convection oven;
(b) monitoring a temperature selection input wherein a user selects a desired temperature by manipulating the temperature selection input; and
(c) applying power to the motor and the open coil heating element when the difference between the actual air temperature and the desired temperature exceeds a selected threshold, and removing power to the motor and the open coil hearing element when the difference between the actual air temperature and the desired temperature is less than the selected threshold.

13. The method of claim 12, wherein the step of measuring an actual air temperature includes positioning a temperature sensor above the open coil heating element.

14. The method of claim 13, further comprising the step of removing power to the open coil heating element when the actual air temperature exceeds a selected maximum limit.

15. The method of claim 10, further comprising:
(a) monitoring the magnitude of a current in the motor;
(b) comparing the magnitude of the current in the motor to a selected maximum limit; and
(c) removing power from the open coil heating element when the magnitude of the current in the motor exceeds the selected maximum limit.

16. The method of claim 10, further comprising:
(a) monitoring the magnitude of a current in the motor;
(b) comparing the magnitude of the current in the motor to a selected minimum limit; and
(c) removing power from the open coil heating element when the magnitude of the current in the motor is less than the selected minimum limit.

17. A convection oven comprising:
(a) oven walls and an oven door defining an oven cavity;
(b) a motor adapted to receive power and to rotate a shaft extending into the oven cavity;
(c) a fan located inside the oven cavity and coupled to the shaft, wherein the fan is configured for producing a radial airflow directed outward from the fan; and
(d) an open coil heating element adapted to receive power and to convert the power into heat, wherein the open coil heating element is formed around the fan whereby at least a portion of the radial airflow passes through the open coil heating element.

18. The convection oven of claim 17 wherein the open coil element comprises a helically wound resistance wire having a plurality of supporting insulators along its length.

19. The convection oven of claim 17 further comprising:
(a) a temperature sensor for measuring an actual temperature;
(b) a temperature selector permitting a user to input a desired temperature; and
(c) a controller operatively coupled to the temperature sensor and to the temperature selector, wherein the controller is further adapted to supply power to the open coil heating element to minimize the difference between the actual temperature and the desired temperature.

20. The convection oven of claim 17 wherein power is supplied to the motor at least when power is supplied to the open coil heating element.

21. The convection oven of claim 17 wherein power is only supplied to the motor when power is supplied to the open coil heating element.

22. The convection oven of claim 17 further comprising:
(a) a current sensor for measuring a current in the motor; and,
(b) a controller operatively coupled to the current sensor, wherein the controller removes power from the open coil heating element when the current in the motor exceeds a threshold value.

23. The convection oven of claim 17 further comprising:
(a) a current sensor for measuring a current in the motor; and,
(b) a controller operatively coupled to the current sensor, wherein the controller removes power from the open coil heating element when the current in the motor is less than a minimum value.
